(19) United States
(12) Patent Application Publication
(10) Pub. No.: US 2015/0134667 A1
(43) Pub. Date: May 14, 2015

(54) Concept Categorization

(71) Applicants: Hui-Man Hou, Beijing (CN); Lijiang Chen, Beijing (CN); Shimin Chen, Beijing (CN); Peng Jiang, Beijing (CN)

(72) Inventors: Hui-Man Hou, Beijing (CN); Lijiang Chen, Beijing (CN); Shimin Chen, Beijing (CN); Peng Jiang, Beijing (CN)

(21) Appl. No.: 14/397,640

(22) PCT Filed: Jul. 31, 2012
(86) PCT No.: PCT/CN2012/079391

§ 371 Date: Oct. 28, 2014

(51) Int. Cl. G06F 17/30

(52) U.S. Cl. CPC G06F 17/30705
USPC 707/740

(57) ABSTRACT

Systems, methods, and computer-readable and executable instructions are provided for categorizing a concept. Categorizing a concept can include selecting a target concept with a number of surrounding textual contexts. Categorizing a concept can also include determining a number of candidate categories for the target concept based on the number of surrounding textual contexts. Categorizing a concept can also include selecting a predefined number of articles, each with a desired relatedness to the number of candidate categories. Furthermore, categorizing a concept can include calculating a relatedness score for each of the number of candidate categories based on a relatedness with the number of articles.

### BACKGROUND

A number of databases can contain large amounts of unstructured text data (e.g., information that does not have a pre-defined data model). The number of databases with unstructured text data can be separated into general categories of information. The general categories can enable a user to navigate information that is in a particular category.

### BRIEF DESCRIPTION OF THE DRAWINGS

FIG. 1 is a flow chart illustrating an example of a method for categorizing concepts according to the present disclosure.

FIG. 2 is a diagram illustrating an example of a categories list and example articles according to the present disclosure.

FIG. 3 is a diagram illustrating an example of a visual representation for categorizing concepts according to the present disclosure.

FIG. 4 is a diagram illustrating an example of a computing device according to the present disclosure.

### DETAILED DESCRIPTION

A number of databases that contain articles (e.g., text articles, text documents, etc.) can be organized by placing a number of articles into particular categories based in part on a particular topic. For example, a database can identify potential concepts within the number of articles available and create a link to the articles (e.g., text, text related information to the potential concepts, etc.). In another example, the database can create a number of categories that potentially relate to a number of concepts within the article. In another example, Wikipedia® can be the database.

Each of the number of categories can also be linked to articles that directly relate the number categories. For example, an article about Avatar can include a first category such as “films by James Cameron”, wherein there is a link to an article about the several films directed by James Cameron. In the same example, a second category can include “films whose art director won the Best Art Direction Academy Award”, wherein there is a link to an article about art directors who have won the Best Art Direction Academy Award.

The number of categories may not be in an order of relevance to the particular article. For example, the first category in the above example can be a lot more relevant to the movie Avatar compared to the second category. Ranking the number of categories based on a relationship (e.g., relatedness, etc.) with a particular article can provide valuable information to users conducting a data search on a particular topic.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

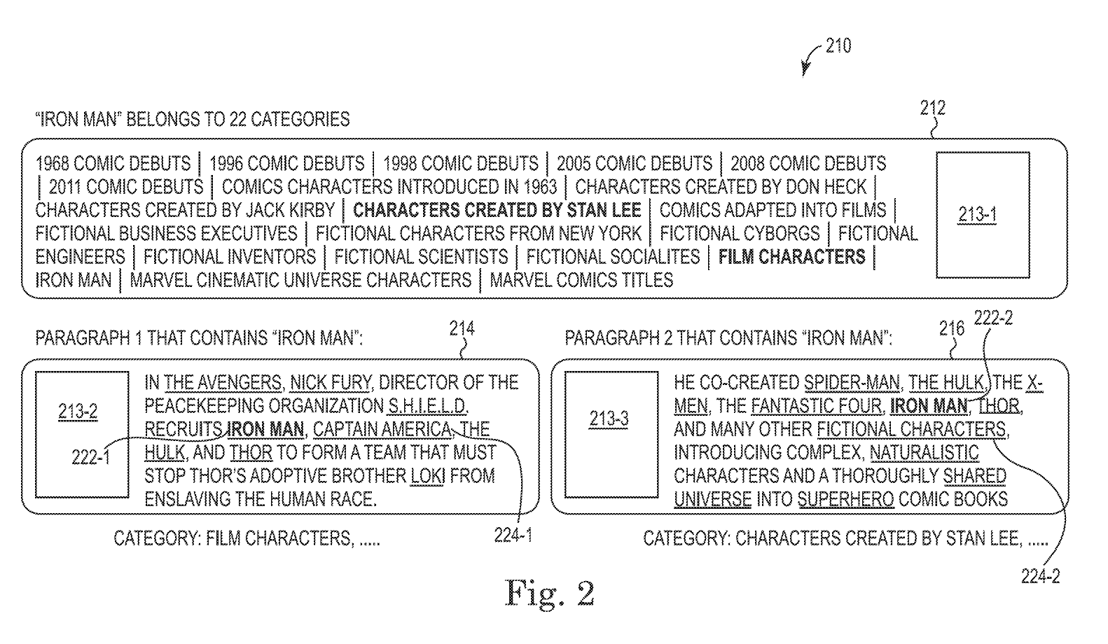

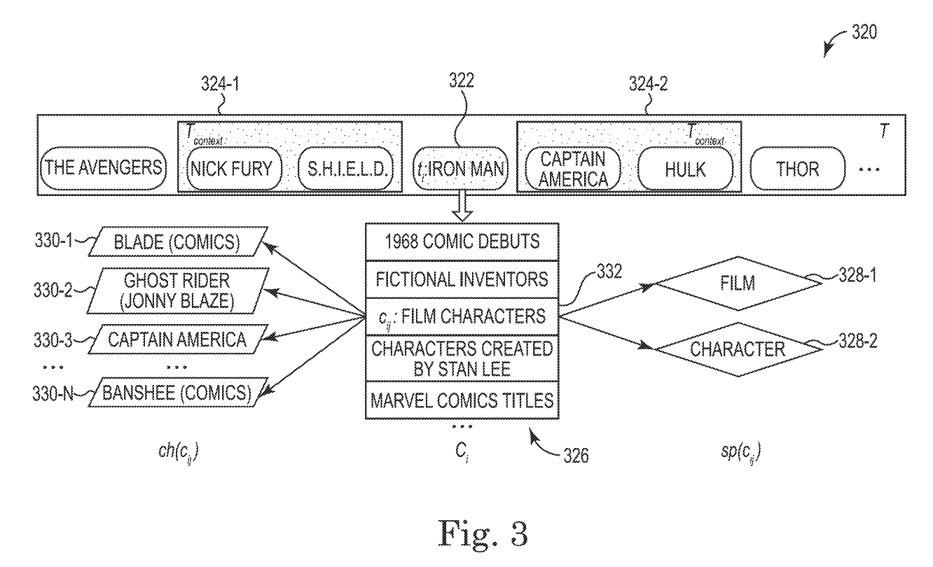

The figures herein follow a numbering convention in which the first digit or digits correspond to the drawing figure number and the remaining digits identify an element or component in the drawing. Similar elements or components between different figures may be identified by the use of similar digits. For example, 222 may reference element “22” in FIG. 2, and a similar element may be referenced as 322 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

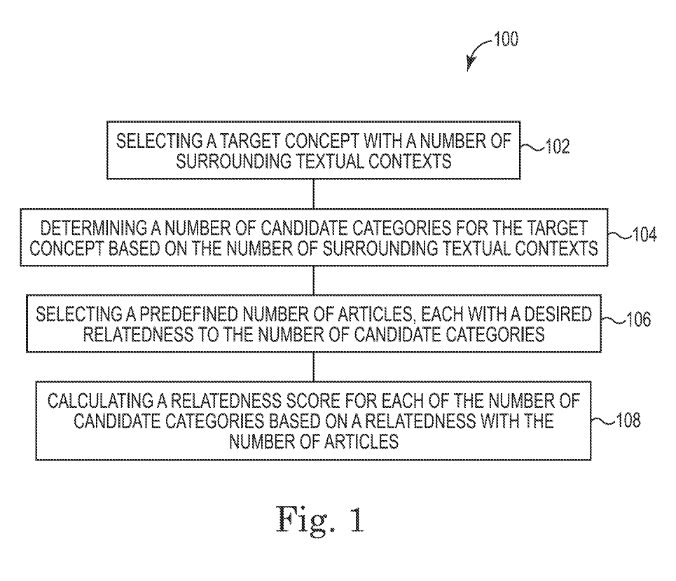

FIG. 1 is a flow chart illustrating an example of a method 100 for categorizing concepts according to the present disclosure. Categorizing concepts can include ranking a number of candidate categories that relate to a particular concept. For example, an article within a database describing “superhero movies” can include a number of concepts such as “Superman”, “Iron Man”, “artists”, “directors”, etc. For each concept within the article, there can also be a number of categories. For example, categories of the concept “iron man” can include “1968 comic debuts”, “film characters”, “characters created by Stan Lee”, etc. Ranking the number of categories can enable a user to efficiently determine the most relevant categories for a particular concept.

At 102 a target concept is selected with a number of surrounding textual contexts. The target concept can be a concept (e.g., topic, etc.) within an article as described herein. The target concept can be linked and/or categorized by a number of categories. For example, the target concept can be “Iron Man” within an article that relates to “superheroes”. In this example, the concept “Iron Man” can be linked to a number of categories (e.g., “characters by Stan Lee”, “film characters”, “Marvel Comics titles”, etc.).

The number of categories can each be linked to a number of articles that have a topic that corresponds to the number of categories. For example, the category “characters by Stan Lee” can be linked to a separate article about the characters that were created by comic book writer Stan Lee.

The target concept can be selected in a number of ways. The target concept can be selected manually by a user and/or automatically via a computing device utilizing a number of modules. For example, a user can manually select a concept within an article for a ranking of a number of categories relating to the selected concept. Concepts within an article can be automatically categorized based on having a number of corresponding categories above a predetermined threshold (e.g., a concept has more than one corresponding category, the concept can be automatically selected as a target concept for having a number of features, etc.). For example, a computing device can scan a particular article and select a number of concepts (e.g., words, text, phrases, sentences, etc.) that have a particular number of categories (e.g., 5, 10, etc.) and automatically rank the particular number of categories for the number of concepts.

There can be surrounding textual context for the target concept. For example, the target concept “Iron Man” can be taken from a list of comic book characters. In this example, the comic book characters that come before and after Iron Man can be included as surrounding textual context. The surrounding textual context can be a predetermined amount of text. For example, the surrounding textual context can be a number of words before the target concept and a number of words after the target concept. The surrounding textual context can be a predetermined number of concepts before and after the target concept. For example, there can be a predetermined number of two concepts before the target concept and two concepts after the target concept that are utilized as the surrounding textual context.

At 104 a number of candidate categories are determined for the target concept based on the number of surrounding textual contexts. The number of candidate categories can be a desired number of categories that relate to the target concept. For example, the number of candidate categories can include predetermined categories within a database that correspond to a particular concept (e.g., target concept, etc.).

The number of candidate categories can include all or a portion of the predetermined categories within a database. For example, if there are 20 categories that correspond to a particular target concept, the number of candidate categories can be all 20 of the categories. In another example, if there are 20 categories that correspond to a particular target concept, the number of candidate categories can be a portion of the 20 categories that are above a predetermined threshold for relatedness to the target concept (e.g., five most related categories to the target concept, top 50% most related categories to the target concept, five categories with an average relatedness for the target concept, etc.).

At 106 a predefined number of articles are selected, each with a desired relatedness to the number of candidate categories. As described herein, a number of articles can be linked to each of the number of candidate categories. For example, if the candidate category is “film characters” there can be a number of articles that relate to the category film characters (e.g., Blade (comics), Ghost Rider, Captain America, etc.). A number of articles can be selected based on a relatedness (e.g., similarity, number of common links, etc.) to the target concept within the surrounding textual context. For example, the number of articles can each be compared to the target concept and surrounding textual context of the target concept to determine a relatedness.

The relatedness can include a calculation as described herein (e.g., Equations 1-9). The calculation can include an evaluation of a number of common links between the number of articles within each candidate category and the target concept. For example, each of the number of articles within each candidate category and the target concept can include a number of links to various secondary concepts. A comparison can be made between the links to secondary concepts of the target concept and the links to the number of articles within each candidate category to determine a relatedness between the target concept and each candidate category.

A number of biases (e.g., factors that can create an undesired weight in determining a relatedness, etc.) can exist for each of the number of candidate categories. For example, a bias can exist for a candidate category if there are a number of incomplete (e.g., limited quantity of information, disputed information, non-cited information, poorly reviewed, etc.) articles relating to the candidate category. In one example, a candidate category can have a bias if the candidate category has a number of articles that are considered unreliable (e.g., non-cited, etc.). In another example, a candidate category can have a bias if the candidate category has a relatively low number of related articles (e.g., fewer than K articles, less articles than the other candidate categories, etc.).

The number of articles within each candidate category can be filtered (e.g., utilizing K number of articles, utilizing K number of articles within a threshold of relatedness, etc.). Filtering the number of articles within each candidate category can eliminate the bias for a particular candidate category. Filtering the articles within each candidate category can include utilizing the same number (e.g., K articles, etc.) of articles for each candidate category to lower the bias for candidate categories with fewer articles. For example, categories with fewer articles can be biased when compared to categories with a greater number of articles, even if the relatedness of the great number of articles is less than the fewer articles.

Filtering the articles within each candidate category can also include utilizing a number of articles that are within an average (e.g., mathematical medium, mathematical mean, etc.) relatedness compared to other articles for the same candidate category. For example, if K number of articles are utilized for each candidate category and there are a greater than K number of articles for a particular candidate category, then a K number of articles that have an average relatedness can be selected from the greater than K number of articles. The average relatedness can include articles that are within a threshold of relatedness for a particular candidate category. This type of filtering can also be implemented when there are fewer than K number of articles available within a particular candidate category. A number of supplemental articles can be added that have a relatedness that is within the average relatedness for the particular category with fewer than K number of articles.

In some examples, the number of candidate categories can be split into a number of sub-component names. The number of sub-component names can include each individual name within a title of the candidate categories that has a number of links to articles associated with the individual name in a database. For example, if the candidate category is “film characters” the sub-component names can include “film” and “characters”. In this example, the individual name within the title “film” can be associated with a number of links to articles relating to films. Also, in this example, the individual name within the title “characters” can also be associated with a number of links to articles relating to characters.

A relatedness for the sub-component categories can be calculated based on the number of links to articles for each of the sub-component names compared to the number of links associated with the target concept. The relatedness can be calculated utilizing an equation as described herein.

The number of articles for the sub-component categories can be filtered to eliminate a bias within the sub-component categories. As described herein, the bias for a particular category (e.g., candidate category, sub-component category, etc.) can exist due to a limited number of related articles and/or from a limited number of quality articles (e.g., cited articles, articles with high reviews, articles with high relatedness, etc.). Filtering the number of sub-component categories can include utilizing K number of articles for each sub-component category. Filtering the number of sub-component categories can also include utilizing K number of articles with a highest relatedness compared to other articles within the same sub-component category. Filtering the number of sub-component categories can be different from filtering the number of candidate categories. For example, the number of sub-component categories may not have a relatively high number of articles with a high relatedness with the target concept when compared to the articles relating to the candidate categories. In this example, the K number of articles can include the highest relatedness articles to avoid utilizing articles with little and/or no relatedness.

At 108 a relatedness score is calculated for each of the number of candidate categories based on a relatedness with the number of articles. The relatedness score can be calculated utilizing an equation that includes the relatedness of the number of articles within each of the number of candidate categories and the target concept. As described herein, the relatedness can include a comparison of a number of links within each of the number of articles and a number of links within the article of the target concept.

In addition, the calculation of a relatedness score for the candidate category can be based upon both of the relatedness of the number of articles within each candidate category and the relatedness for the sub-component categories (e.g., combined calculated relatedness). As described herein, each of the number of candidate categories can be split into the sub-component categories. Each sub-component category can be evaluated to calculate a relatedness to the target concept. The relatedness of the sub-component categories for each of the number of candidate categories can be utilized to calculate the relatedness score of each of the number of candidate categories.

The relatedness score for each of the number of candidate categories can be utilized to rank the number of candidate categories by relatedness to the target concept. For example, the relatedness score can be utilized to rank the number of candidate categories from a most related category to a least related category. The most related category can be more related to the target concept compared to the least related category. Ranking the number of candidate categories and displaying the ranking of the number of candidate categories can enable a user (e.g., interested party of the target concept, etc.) to browse categories of the target concept based on how related (e.g., relevant, associated, interconnected, trusted, rated, etc.) the category is to the target concept.

FIG. 2 is a diagram illustrating an example of a categories list 212 and example articles 214, 216 according to the present disclosure. The categories list 212 can include a number of categories that each comprise a particular relatedness to a target concept. The target concept in the diagram is “Iron Man”. The target concept “Iron Man” includes the number of categories displayed in the categories list 212. There are 22 categories displayed for the target concept “Iron Man”. There can also be a picture 213-1 that relates to the target concept. The picture 213-1 can be a photograph and/or a depiction of the target concept. The picture 213-1 can also be linked to an article and/or website that can relate to the target concept.

Each of the number of categories within the categories list 212 can have a link to a number of articles 214, 216. For example, the category “Film Characters” within the categories list 212 can have a link to the article 214. Article 214 can include the target concept “Iron Man” 222-1 within a particular paragraph (e.g., first paragraph, introduction, abstract, etc.) of the article 214. The target concept “Iron Man” 222-1 can be surrounded by a number of surrounding textual context (e.g., words/phrases within the article other than the target concept, etc.). In this example, the surrounding textual context can include the phrase “Captain America” 224-1.

In another example, the category “Characters created by Stan Lee” can also have a link to the article 216. Article 216 can also include the target concept “Iron Man” 222-2 within a particular paragraph of article 216. The target concept “Iron Man” 222-2 can include surrounding textual context as described herein. For example, the surrounding textual context can include the phrase “Fictional Characters” 224-2.

The surrounding textual context can be utilized to calculate a relatedness of a particular candidate category for a target concept within a particular context. The relatedness of candidate category to a target concept can be different based on the surrounding textual context. For example, the target concept “Iron Man” 222-1 can have a different relatedness to a particular candidate category with a surrounding textual context of “Captain America” 224-1 compared to a surrounding textual context of “Fictional Characters” 224-2.

Each of the number of articles 214, 216 can also include a picture 213-2 and picture 213-3 respectively. Each picture 213-2, 213-3 can also include a link to a respective website and/or article that relates to the number of articles 214, 216. The website and/or articles that are linked to the picture 213-2, 213-3 can also include a link to a location (e.g., data location, machine readable medium, etc.) where the picture 213-2, 213-3 is stored.

FIG. 3 is a diagram 320 illustrating an example of a visual representation for categorizing concepts according to the present disclosure. The diagram 320 is a graphical representation of information of a number of links accessed (or attempted to be accessed) by the hosts. However, the “diagram”, as used herein, does not require that a physical or graphical representation (e.g., candidate categories 326, sub-component categories 328-1, 328-2, child articles 330-1, 330-2, . . . , 330-N, etc.) of the information actually exists. Rather, such a diagram 320 can be represented as a data structure in a tangible medium (e.g., in memory of a computing device). Nevertheless, reference and discussion herein may be made to the graphical representation (e.g., candidate categories 326, sub-component categories 328-1, 328-2, child articles 330-1, 330-2, . . . , 330-N, etc.) which can help the reader to visualize and understand a number of examples of the present disclosure.

The diagram 320 can include a target concept 322 (e.g., Iron Man, tᵢ, etc.). The target concept 322 can be text from within a paragraph (e.g., Text (T), etc.) of other text that can include a number of surrounding textual contexts 324-1, 324-2 (e.g., Nick Fury, S.H.I.E.L.D, Captain America, Hulk, T_{context}, etc.). The surrounding textual context 324-1, 324-2 can include a quantity of text that is found earlier in the paragraph compared to the target concept 322 (e.g., surrounding textual context 324-1). The surrounding textual context 324-1, 324-2 can also include a quantity of text that is found later in the paragraph compared to the target concept 322 (e.g., surrounding textual context 324-2).

Surrounding textual contexts 324-1, 324-2 can be selected to include text that if before and after the target concept 322 to get a further understanding of the context of the paragraph that includes the target concept 322. For example, the surrounding textual contexts 324-1, 324-2 can be evaluated to determine a number of links for each of the surrounding textual contexts 324-1, 324-2. The number of related (e.g., correspond to each of the surrounding textual contexts 324-1, 324-2, utilized within articles relating to the surrounding textual contexts 324-1, 324-2, etc.) links can be utilized within an equation to calculate the relatedness score of each of the number of candidate categories as described herein.

The surrounding textual contexts 324-1, 324-2 can be utilized with the target concept to determine and/or select a number of candidate categories 326 (e.g., 1968 Comic Debuts, Fictional Inventors, Cᵢ, etc.). The list of candidate categories 326 can include a number of categories (e.g., topic headings, links to related articles, etc.) each with varying relatedness to the target concept 322. For each of the number of candidate categories 326 a relatedness score can be calculated utilizing a number of child articles 330-1, 330-2, . . . , 330-N (e.g., Blade, Ghost Rider, Captain America, ch(cᵢⱼ), etc.) and a number of sub-component categories 328-1, 328-2 (e.g., each word within the candidate category, a word within the candidate category that corresponds to a number of links, sp(cᵢⱼ), etc.). The relatedness score can be utilized to rank the number of candidate categories. A ranked list of candidate categories can be displayed to a user for selection to the number of corresponding links and/or articles that correspond to the number of candidate categories. For example, a selected candidate category 332 (e.g., Film Characters, cᵢⱼ, etc.) can have a number of child articles 330-1, 330-2, . . . , 330-N and be split into a number of sub-component categories 328-1, 328-2 that can be used to calculate the relatedness score for the selected candidate category 332.

Diagram 320 includes candidate category “Film Characters” as the selected category 332. The selected category 332 can be split into sub-component categories 328-1, 328-2. For example, the candidate “Film Characters” can be split into sub-component category “Film” 328-1 and sub component category “Character” 328-2. As described herein, each of the number of sub-component categories can be evaluated to determine a relatedness with the target concept 322. Also, the number of sub-component categories can be filtered to eliminate a bias.

As described further herein, the sub-component categories can be filtered by limiting the number of sub-component categories used in the calculation of the relatedness score. For example, each of the sub-component categories 328-1, 328-2 can be evaluated for a relatedness to the target concept 322. In the same example, a predetermined number (K, etc.) of sub-component categories can be selected to utilize in the calculation of the relatedness score for the selected candidate category 332.

The sub-component categories 328-1, 328-2 that are determined to have a high relatedness compared to the other sub-component categories 328-1, 328-2 within the same candidate category 332 can be selected. In the same example, the sub-component categories 328-1, 328-2 that are determined to have a low relatedness compared to the other sub-component categories 328-1, 328-2 within the same candidate category 332 can be removed from the relatedness score calculation for the candidate category 332.

The selected candidate category 332 can also include a number of child articles 330-1, 330-2, . . . , 330-N. The number of child articles 330-1, 330-2, . . . , 330-N can be articles that relate to the selected candidate category 332. For example, the number of child articles 330-1, 330-2, . . . , 330-N can be found within the text of the selected candidate category 332.

The number of child articles 330-1, 330-2, . . . , 330-N can also be filtered to eliminate a bias when comparing the number of candidate categories 326. As described herein, each of the number of child articles can have a relatedness to the target concept 322. As described herein, the relatedness can include a determination of a common number of links to related articles. The relatedness to the target concept can be utilized to filter the number of child articles 330-1, 330-2, . . . , 330-N. In one example, the number of child articles 330-1, 330-2, . . . , 330-N are limited to a predetermined number of child articles 330-1, 330-2, . . . , 330-N (e.g., K articles, etc.). If the number of child articles 330-1, 330-2, . . . , 330-N exceeds the predetermined number of child articles 330-1, 330-2, . . . , 330-N, a selection process can be initiated to select the predetermined number of child articles 330-1, 330-2, . . . , 330-N.

The selection process can be based on the relatedness of each of the number of child articles 330-1, 330-2, . . . , 330-N with the target concept 322. For example, a predetermined threshold of relatedness can be determined by taking an average relatedness of each of the number of child articles 330-1, 330-2, . . . , 330-N. The predetermined number of child articles 330-1, 330-2, . . . , 330-N can be selected that are within the predetermined threshold.

Each of the candidate categories 326 can be evaluated as described herein and the relatedness score can be calculated for each of the candidate categories 326 to determine a rank of relatedness to the target concept 322 for each of the candidate categories 326. A number of equations are provided herein that can be utilized to calculate the relatedness score described herein. A number of equations are also provided herein that can be utilized to rank the number of candidate categories 326 for a relatedness to the target concept 322.

A relatedness equation can be utilized to compute a relatedness between a first concept tᵢ and a second concept tⱼ (e.g., r(tᵢ,tⱼ)). The equation can include a link set (ln(a)), where a is a corresponding article of either the first concept tᵢ (e.g., aᵢ) and/or the second concept tⱼ (e.g., aⱼ).

The equation can utilize the link set of the first concept tᵢ and the second concept tⱼ to measure a relatedness between the first concept tᵢ and the second concept tⱼ. The link set can include inlinks (e.g., incoming links, etc.) and/or outlinks (e.g., outgoing links, etc.) as indicators of relevance. The greater quantity of common links (e.g., links that are the same for each concept, etc.) can result in a greater relatedness between two concepts and/or categories as described herein.

As described herein there can be a limited number of related links within a particular category. There can also be a limited number of quality related links within a particular category (e.g., popular links, links with a high relatedness, etc.). The limited number of related links within a particular category can result in no common links between a number of articles within the same category. If there are no common links between the number of articles then a value of zero can result.

Equation 1 can be utilized to compensate for a lack of common links within the relatedness equation. For example, Equation 1 can be a probability model θₜ that can represent a concept t as a probability distribution over links. Equation 1 can assume that there is an unseen link (e.g., outlink to a different website, etc.) within the concept t to have a probability of occurrence.

Within Equation 1 n(linkt) can be a number times a particular link appears in the article corresponding to t. In addition, |t| can be a number of links within concept t. Furthermore, μ can be a Dirichlet parameter and/or a constant value.

$$p ( link \vert {θ}_{t} ) = \frac{n ( link ; t ) + μ p ( link \vert C )}{\vert t \vert + μ} \qquad Equation 1$$

Within Equation 1 the p(link|C) value can be solved utilizing Equation 2.

$$p ( link \vert C ) = \frac{{\sum }_{c ∈ C} {\sum }_{a ∈ c} \vert n ( link ; a ) \vert}{{\sum }_{c ∈ C} {\sum }_{a ∈ c} \vert a \vert} \qquad Equation 2$$

Within Equation 3 c can be a category of t in C. In addition, a can be an article that belongs to c. In addition, |a| can include the number of links within article a. Each concept in c can share all links of c with the probability related to the frequency of the link occurring in c.

A semantic relatedness can be calculated between the first concept tᵢ and the second concept tⱼ utilizing Equation 3.

r(tᵢ,tⱼ)=D(θᵢ∥θⱼ)−D(θⱼ∥θᵢ) Equation 3

As described herein, r(tᵢ,tⱼ) can be a relatedness between concept tᵢ and concept tⱼ. Within Equation 3, D(θᵢ∥θⱼ) can be a Kullback-Leibler divergence (e.g., KL divergence and/or distance). The KL divergence can be a non-symmetric measure of a difference between two probability distributions of a “true” distribution of data and a theory (e.g., model, description, etc.) of the “true” distribution of data. Thus, D(θᵢ∥θⱼ) can be solved utilizing Equation 4.

$$D ( {θ}_{i} \vert \vert {θ}_{j} ) = {\sum }_{link} p ( link \vert {θ}_{i} ) log \frac{p ( link \vert {θ}_{i} )}{p ( link \vert {θ}_{j} )} \qquad Equation 4$$

Utilizing Equation 4 can result in a relatively smaller value of D(θᵢ∥θⱼ) that can be interpreted as a relatively higher relatedness of concept tᵢ and concept tⱼ. The negative KL divergence can be utilized to measure the relatedness between concept tᵢ and concept tⱼ. If concept tᵢ and concept tⱼ are the same concept, the D(θᵢ∥θⱼ) can equal 0.

Based on the previous equations (e.g., Equation 1-Equation 4) a relevance and/or relatedness between a category c and a concept t can be calculated (e.g., R(t,c) Equation 5 can be utilized to calculate R(t,c).

$$\begin{matrix}R ( t , c ) = α R ( t , {ch}^{′} ( c ) ) + ( 1 - α ) R ( t , sp ( c ) ) \\ = α \frac{1}{K} {\sum }_{{t}_{i} ∈ c {h}^{′} ( c )} r ( t , {t}_{i} ) + ( 1 - α ) {max}_{{t}_{i} ∈ sp ( c )} r ( t , {t}_{i} )\end{matrix} \qquad Equation 5$$

Within Equation 5, R(t,ch′(c)) can be the relatedness between a concept t and a number of child articles (ch′(c)) as described herein. The number of child articles (ch′(c)) can be filtered as described herein. In addition, R(t, sp(c)) can be the relatedness between concept t and a number of split articles sp(c) (e.g., sub-component category, etc.). In addition, α can equal a number of weight parameters utilized to influence a weight of two category representations. In addition, K as described herein, can be a pseudo size (e.g., predetermined number of child articles, etc.) of each category. If the number of child articles ch′(c) is less than a predetermined threshold a concept can be selected and utilized to add a child article to the number of child articles using Equation 6 for selecting the concept to be added.

$${t}_{min} = {arg min}_{{t}_{i}} r ( t , {t}_{i} ) \qquad Equation 6$$

Equation 5 can be rewritten utilizing Equation 6 to produce Equation 7.

$$R ( t , {ch}^{′} ( c ) ) = \frac{1}{K} ( {\sum }_{i = 1}^{{n}^{′}} r ( t , {t}_{i} ) + ( K - {n}^{′} ) r ( t , {t}_{min} ) ) \qquad Equation 7$$

Within Equation 7 n′ can be an actual size of the number of child articles ch′(c). As described herein, the number of child articles can be kept to a predetermined number (K) to prevent a bias when comparing a number of candidate categories. By utilizing the same predetermined number (K) of child articles, each child article can have a same contribution (e.g., weight, etc.) to a total relatedness score. For example, if a first candidate category has two child articles that included values of 0.8 and 0.2 and a second candidate category has three child articles that included values of 0.8, 0.3, and 0.3 a simple average (e.g., mean, etc.) could place the first candidate category with a higher relatedness score compared to the second candidate category. For example, the simple average could include adding each of the values and dividing by the total number of values. The simple average can result in a value that could rank the first candidate category higher than the second candidate category.

In this same example, if it was determined that K would equal 3 (e.g., 3 child articles), it could be determined that a third child article should be selected for the first candidate category. The child article that could be selected can be the lowest value child article (e.g., 0.2). In this example, each candidate category would have 3 child articles, the first candidate category would have values of 0.8, 0.2 and 0.2* (*added child article) and the second candidate category would have values of 0.8, 0.3, and 0.3. In this example, the second candidate category can have a higher relatedness score compared to the first candidate category.

Equation 8 can incorporate the surrounding textual contexts as described herein. Equation 8 can also be considered a scoring function that can be utilized to calculate a relatedness score as described herein.

$$score ( {t}_{i} , {c}_{ij} ) {=}^{rank} \frac{β}{\vert {T}_{{context}_{i}} \vert} {\sum }_{{t}^{′} ∈ {T}_{{context}_{i}}} R ( {t}^{′} , {c}_{ij} ) + ( 1 - β ) R ( {t}_{i} , {c}_{ij} ) \qquad Equation 8$$

Within Equation 8, R(t′, cᵢⱼ) can be the relatedness between a surrounding contextual context t′ and a candidate category c of a target concept tᵢ. In addition, R(tᵢ, cᵢⱼ) can be a relatedness between the target concept tᵢ and the corresponding category without a consideration of the surrounding contextual context. Furthermore, β can be a parameter utilized to control an influence weight of the surrounding contextual context. A ranking score from Equation 8 can be calculated for each of the number of candidate categories and then ranked in an order (e.g., descending order, etc.) based on the score.

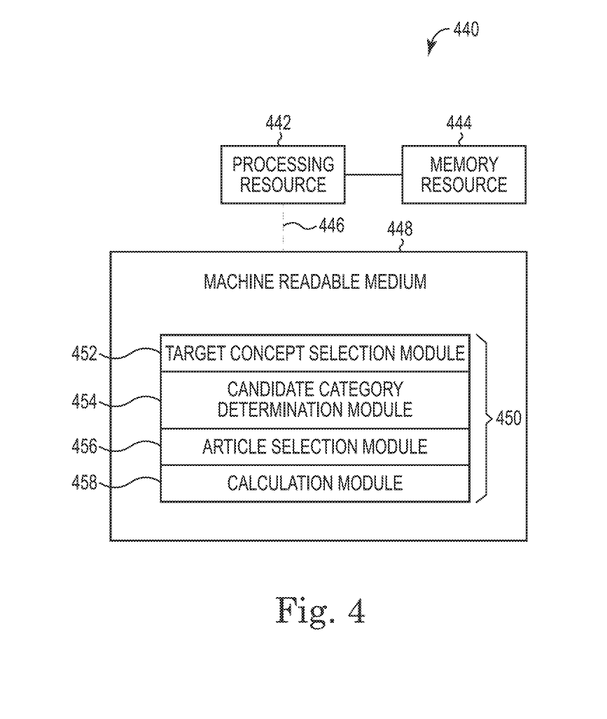

FIG. 4 is a diagram illustrating an example of a computing device 440 according to the present disclosure. The computing device 440 can utilize software, hardware, firmware, and/or logic to rank number of categories for a particular concept.

The computing device 440 can be any combination of hardware and program instructions configured to provide a simulated network. The hardware, for example can include one or more processing resources 442, machine readable medium (MRM) 448 (e.g., computer readable medium (CRM), database, etc.). The program instructions (e.g., computer-readable instructions (MRI) 450) can include instructions stored on the MRM 448 and executable by the processing resources 442 to implement a desired function (e.g., select a target concept, calculate a relatedness score, etc.).

The processing resources 442 can be in communication with a tangible non-transitory MRM 448 storing a set of MRI 450 executable by one or more of the processing resources 442, as described herein. The MRI 450 can also be stored in remote memory managed by a server and represent an installation package that can be downloaded, installed, and executed. The computing device 440 can include memory resources 444, and the processing resources 442 can be coupled to the memory resources 444.

Processing resources 442 can execute MRI 450 that can be stored on an internal or external non-transitory MRM 448. The processing resources 442 can execute MRI 450 to perform various functions, including the functions described herein. For example, the processing resources 442 can execute MRI 450 to select a target concept with a number of surrounding textual contexts 102 from FIG. 1.

The MRI 450 can include a number of modules 452, 454, 456, 458. The number of modules 452, 454, 456, 458 can include MRI that when executed by the processing resources 442 can perform a number of functions.

The number of modules 452, 454, 456, 458 can be sub-modules of other modules. For example, a target concept selection module 452 and an article selection module 456 can be sub-modules and/or contained within same computing device 440. In another example, the number of modules 452, 454, 456, 458 can comprise individual modules on separate and distinct computing devices.

A target concept selection module 452 can include MRI that when executed by the processing resources 442 can perform a number of functions. The target concept selection module 452 can select a target concept within an article. The target concept selection module 452 can also determine and/or select a number of surrounding contextual context of the target concept.

A candidate category determination module 454 can include MRI that when executed by the processing resources 442 can perform a number of functions. The candidate category determination module 454 can determine a number of candidate categories to rank for the selected target concept. The candidate category determination module 454 can also eliminate a number of candidate categories that are below a predetermined threshold of relatedness. The candidate category determination module 454 can also split the number of candidate categories into a number of sub-component categories.

An article selection module 456 can include MRI that when executed by the processing resources 442 can perform a number of functions. The article selection module 456 can select a number of articles within each of the candidate categories as described herein. The article selection module 456 can also add a number of articles (e.g., child articles) and/or a number of article values if the number of selected articles is below a predetermined threshold. The article selection module can also eliminate a number of articles if the number of selected articles exceeds a predetermined threshold.

A calculation module 458 can include MRI that when executed by the processing resources 442 can perform a number of functions. The calculation module 458 can perform the number of calculations as described herein. For example, the calculation module 458 can utilize the number of equations described herein to calculate a relatedness value for each of the number of candidate categories. In another example, the calculation module 458 can utilize the relatedness value of each of the number of candidate categories to rank the number of candidate categories in an order (e.g., descending order, etc.)

A non-transitory MRM 448, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 448 can be integral, or communicatively coupled, to a computing device, in a wired and/or a wireless manner. For example, the non-transitory MRM 448 can be an internal memory, a portable memory, a portable disk, or a memory associated with another computing resource (e.g., enabling MRIs to be transferred and/or executed across a network such as the Internet).

The MRM 448 can be in communication with the processing resources 442 via a communication path 446. The communication path 446 can be local or remote to a machine (e.g., a computer) associated with the processing resources 442. Examples of a local communication path 446 can include an electronic bus internal to a machine (e.g., a computer) where the MRM 448 is one of volatile, non-volatile, fixed, and/or removable storage medium in communication with the processing resources 442 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 446 can be such that the MRM 448 is remote from the processing resources e.g., 442, such as in a network connection between the MRM 448 and the processing resources (e.g., 442). That is, the communication path 446 can be a network connection. Examples of such a network connection can include a local area network (LAN), wide area network (WAN), personal area network (PAN), and the Internet, among others. In such examples, the MRM 448 can be associated with a first computing device and the processing resources 442 can be associated with a second computing device (e.g., a Java® server). For example, a processing resource 442 can be in communication with a MRM 448, wherein the MRM 448 includes a set of instructions and wherein the processing resource 442 is designed to carry out the set of instructions.

The processing resources 442 coupled to the memory resources 444 can execute MRI 450 to determine a number of candidate categories for a target concept based on a number of surrounding textual contexts. The processing resources 442 coupled to the memory resources 444 can also execute MRI 450 to select a first number of articles, each with a desired relatedness to the number of candidate categories. The processing resources 442 coupled to the memory resources 444 can also execute MRI 450 to split each of the number of candidate categories into a number of sub-component names, wherein the sub-component names correspond to a second number of articles. The processing resources 442 coupled to the memory resources 444 can also execute MRI 450 to select a desired number of articles from the first number of articles and a desired sub-component name from the number of sub-component names. Furthermore, the processing resources 442 coupled to the memory resources 444 can execute MRI 450 to calculate a ranking of the candidate categories relatedness to the target concept based on a combined calculated relatedness of the first number of articles and the target concept and the second number of articles that correspond to the desired sub-component and the target concept.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

As used herein, “a” or “a number of” something can refer to one or more such things. For example, “a number of nodes” can refer to one or more nodes.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for categorizing concepts, comprising:
selecting a target concept with a number of surrounding textual contexts from an article;
determining a number of candidate categories for the target concept based on the number of surrounding textual contexts;
selecting a number of additional articles, each with a desired relatedness to the number of candidate categories; and
calculating a relatedness score for each of the number of candidate categories based on a relatedness with the number of articles.

2. The method of claim 1, wherein selecting the number of additional articles includes eliminating a number of articles with a number of links below a predetermined threshold.

3. The method of claim 1, wherein selecting the number of additional articles includes eliminating a number of articles exceeding a predetermined threshold.

4. The method of claim 3, wherein eliminating articles exceeding the predetermined threshold includes calculating the relatedness between each article and a number of other articles in the number of candidate categories.

5. The method of claim 1, wherein calculating the relatedness score includes supplementing a number of numerical values for a candidate category if the number of articles are below a predetermined threshold.

6. The method of claim 5, wherein the supplemented number of articles have a score that is equal to a lowest relatedness score article.

7. A non-transitory machine-readable medium storing a set of instructions executable by a processor to cause a computer to:
determine a number of candidate categories for a target concept based on a number of surrounding textual contexts;
split each of the number of candidate categories into a number of sub-component categories;
calculate a relatedness between each of the number of sub-component categories and the target concept; and
rank the number of candidate categories based on the relatedness between each of the number of sub-component categories and the target concept.

8. The medium of claim 7, wherein the sub-component categories are filtered to eliminate a bias.

9. The medium of claim 7, further comprising a set of instructions to rank the number of candidate categories based on a desired sub-component relatedness and a relatedness of the candidate categories with a number of articles.

10. The medium of claim 7, wherein the number of sub-component categories include a number of variant names for each of the number of candidate categories.

11. The medium of claim 7, wherein each of the number of sub-component categories include an article.

12. A computing system for categorizing a concept, comprising:
a memory resource;
a processing resource coupled to the memory resource to implement:
a candidate category determination module to determine a number of candidate categories for a target concept based on a number of surrounding textual contexts;
an article selection module to select a first number of articles, each with a desired relatedness to the number of candidate categories;
the candidate category determination module to split each of the number of candidate categories into a number of sub-component names, wherein the sub-component names correspond to a second number of articles;
the article selection module to select a desired number of articles from the first number of articles and a desired sub-component name from the number of sub-component names; and
a calculation module to calculate a ranking of a relatedness of the number of candidate categories to the target concept based on a combined calculated relatedness of:
the first number of articles and the target concept; and
the second number of articles that correspond to the desired sub-component and the target concept.

13. The computing system of claim 12, wherein the combined calculated relatedness utilizes a predetermined number of articles with an average relatedness of the first number of articles and the target concept.

14. The computing system of claim 12, wherein the combined calculated relatedness utilizes a predetermined number of articles with a maximum relatedness of the second number of articles and the target concept.

15. The computing system of claim 12, wherein the relatedness is calculated utilizing a number of common links.
